(19) United States
(12) Patent Application Publication
(10) Pub. No.: US 2020/0111070 A1
(43) Pub. Date: Apr. 9, 2020

(54) SYSTEM OF SORTING DATA TRANSFER PROCESSORS BASED ON DATA TRASFER TRACKING BY A CONTROL PROCESSOR AND DISTINGUISHING BETWEEN UNIQUE AND REPEAT DATA TRASFERS

(71) Applicant: Gibran Ali Malik, Jamaica, NY (US)

(72) Inventor: Gibran Ali Malik, Jamaica, NY (US)

(21) Appl. No.: 16/153,548

(22) Filed: Oct. 5, 2018

(51) Int. Cl. G06Q 20/10

(52) U.S. Cl. CPC G06Q 20/10

(57) ABSTRACT

A system featuring a network of processors, including a control processor which tracks data transfers between the processors, distinguishes between unique and repeat data transfers, and orders the processors according to the quality and quantity of those unique and repeat data transfers, with repeat data transfers being prioritized over unique data transfers.

### BACKGROUND

Data production and transmission is a service provided by one party to another, usually a business to another business or individual, and usually over a network. The data may relate to business interests, such as digital media, news, or financial information, or it may relate to personal interests, such as one's medical information, including lab reports, diagnosis history, or prescriptions. It is important that the data production and transmission be executed correctly and professionally, and it is therefore important to access information that can help a business select another business for its data production and transmission needs. Currently, businesses must generally rely on reviews, marketing materials, and word- of-mouth referrals to select such service providers. What is needed is a sorting mechanism that tracks data relating to the service.

### SUMMARY

The system may comprise one or more processors connected over a network, a database and a user interface. The user interface may be displayed on display screens coupled to the processors and interacted with by users via one or more input devices such as a keyboard, mouse, or touch screen. The processors, display screens, and input devices may form personal or corporate computers or mobile devices such as smart phones or tablets. The database may be stored at a set of central processors or distributed across a set of processors including processors owned by users. The database may receive requests from the system's back end based on user requests as received via the user interface and may save and retrieve data relating to transactions, specifically the parties, monetary amounts, and goods or services for which the transaction is executed.

The user interface may include a set of profile pages, a search interface, and a communications interface, each of which may be simultaneously or separately displayed on a display screen. The pages and interfaces may be navigated by selecting tabs that may be positioned horizontally or vertically adjacent to a border, swiping up, down, right, or left, or by clicking links appearing as text or image.

A profile page may include a photo or visual representation of the user, which may be uploaded by a user or sourced from the internet, including via the API of one or more social media platforms such as Facebook. The profile page may include a discrete section describing the user and the user's work, specifically relating to the music and art industry, such as being a lyricist, an instrumentalist, an audio engineer, a live musician, or a photographer. The system may also be adopted for other industries such as manufacturing, education, marketing, etc. A profile page may include a virtual or digital representation of goods produced or services rendered by the user on behalf of another user. This representation may include text, video, audio, images, and/or interactive content and may be uploaded from a computer or sourced from the internet.

A profile may also receive location information from a user, which identifies a user's general geographical area. This information allows other users to determine whether it is logistically possible to work with the user. Alternately, the user may automatically (or manually) submit geographical information via the user's GPS coordinates as determined by the user's mobile device. This will be useful in case a user is travelling, give other users the opportunity to reach out if they otherwise would not have because of the user's default location.

The profile page may include information relating to previous transactions, specifically detailing the other users with whom the user has worked with, the number of unique, repeat, or total transactions for a given good or service or with a given user. Unique transactions may be determined by equating multiple transactions with a single user as one, either regardless of the goods or services, or in regard to a particular good or service. For example, if seven transactions are made between two sets of users, with three and four of the transactions concerning a first set of goods and a second set of goods, respectively, then the repeat transaction number may be one for all seven, or two for seven, depending on whether repeat transactions are counted using the user or the user and exchange. Repeat transactions may be determined by adding up the number of transactions in which more than one transaction has occurred with a given user. Total transactions may be determined by adding all transactions, regardless of whether any set of transactions were executed on behalf of a single user. When calculating repeat transactions, a repeat transaction may encompass a service or an area of expertise, such as a genre, skill, or technique.

Information relating to transactions are stored in the database. The database records each transaction, the monetary amount for each transaction, and the monetary flow for each transaction, the flow corresponding with the monetary direction of the transaction. Flow may be described as moving toward the supplier of goods or services, because the supplier is paid for the goods or services. Information may be at least partially duplicative. If a first transaction occurs between a first user and a second user, that transaction is stored under unique and total transactions categories for each user. If a second transaction occurs between the first user and the second user, that transaction is stored under repeat and total transaction categories for each user. In a variation, once information relating to the second transaction is received, information for the first transaction is removed from the unique category and saved under a repeat category for each user along with information relating to the second transaction.

Transaction information may be displayed and accessed on the profile page.

Information may be separated into separate graphical areas corresponding to unique and repeat transactions. If the graphical area corresponding to unique transactions or repeat transactions is selected by a user, then more detailed information relating to the unique transactions or repeat transactions, respectively, are displayed, either in the same graphical area with the rest of the profile page remaining the same, or on a separate page. The more detailed information may include a list or set of the transactions that make up the transaction category, including identification of the goods or services or users for which or whom the transaction occurred. Goods, services, and users may be represented as broad categories represented by text or image, which may then be selected to reveal the individual transactions that make up the category, or the individual transactions may be displayed once the unique or repeat category is selected. Individual transactions under different goods, service, or user categories may also be displayed simultaneously but organized in separate graphical areas.

Selecting a good or service representation may cause information relating to that good or service to be displayed, including a description of the good or service, pricing, turn-around time, and a representation of the finished product or sample thereof. Selecting a user may cause the user's profile page to be displayed.

The system may provide a search interface. Users may enter the names of other users in a search field, and the system will display a set of profiles relating to or encompassing the names entered. More importantly, users may enter goods or services. In one variation, the system may display goods or services pages relating to or encompassing the goods or services entered. In another variation, the system may display the profiles of users who provide those goods or services. The order in which those profiles appear depend on the transactional information associated with each profile. The system may rely on the total transactional information available and stored in the database, or a specific subset, such as transactional information that relate to the goods or services sought. The system may use an algorithm which takes into account both repeat transaction information and unique transaction information when determining search result order. The system may specifically determine order using the number of repeat transactions and the number of unique transactions, with the numbers of each type of transaction multiplied by a constant or other variable. The numbers used may include all transactions, all repeat transactions, all unique transactions, and/or only transactions relating to the good or service sought. Transactions relating to the good or service sought may be given more weight than transactions unrelated to the good or service. Repeat transactions may be given more weight than unique transactions. Transactions associated with a higher monetary amount may be given greater weight than transactions associated with a lower monetary amount. Transactions associated with a monetary amount below some threshold may not be included in the algorithm to determine order. Recent transactions may be given a greater weight than less recent transactions.

Providers of goods and services may issue a discount. This issuance may affect their weight by increasing their value by a constant or variable proportionate to the discount, thereby increasing their order in search results. In one variation, providers issuing discounts are placed in a separate section of the results, either additionally to their regular placement or instead of it.

Providers may be classified according to their pricing—low, medium, or high. More nuanced pricing classifications may also be used, such as very low or very high. The classification may be represented by dollar signs or similar magnitude expressions.

Search results may be ordered by the user based one or more factors. The user may select from a drop-down menu of factors the user wishes to be emphasized in the search, such as price, popularity, alphabetical order, etc. Users can also limit search results to providers who are providing a discount, their pricing classification, or their location.

The system may provide for a communications tab.

The system may provide for a projects tab. In one embodiment, the user interface may display a set of tasks or projects, each associated with a set of goods or services required to complete them. Additionally, a budget may be assigned by the user for any given task or project, and the system will adjust the goods or services associated with the task or project based on the budget. Once the task or project is selected by the user, the goods or services associated with the task or project are displayed. The system may identify a price or price estimate for each good or service listed. The system may also recommend one or more users who can provide the good or service and display their profile representation adjacent to the good or service. This recommendation may be based on the price listed for the good or service, which in turn may be based on the budget set by the user. In one embodiment, the user may select the good or service as displayed in the project tab and the system will display a set of users that provide the good or service selected. The system may display a completion category adjacent to the good or service category. When a good or service is purchased by a user, a first color or mark may appear adjacent to it. When a good or service is completed by the supplying user, a second color or mark may appear adjacent to it. In one variation, when a user selects a good or service and sends messages to users providing the good or service, those messages or the users to whom the messages are sent will be displayed.

The system may provide for different kinds of user accounts. A first user account holder may be a purchaser of goods or services. A second user account holder may be a provider of goods or services. These two user accounts may not be mutually exclusive—a user may be simultaneously a purchaser and provider of goods or services. However, there may be a different cost structure entailed in using the system for each type of account activity.

In one variation, purchasers pay a percentage and/or fixed fee to the system operators via a payment transaction interface. The fixed fee payment may be required as a minimum, plus a percentage of the total transaction amount subtracting the fixed fee if the percentage is above the fixed fee. In another variation, the provider pays this payment. In yet another variation, the provider and the purchaser both pay transaction fees or a portion of the transaction fee. In another variation, purchasers and/or providers pay a subscription or a one-time fee to access and use the system.

In yet another variation, users must pay a fee in order to connect with other users. A connection, established via a connection request prompt, may in one variation, require consent by the other user, and in another variation, not require consent by the other user. In one version, both parties must pay a connection fee in order to connect while in another version, only the requesting party must pay the connection fee. In one variation, the connection is required to contact another user. In another variation, contact is free but a connection is required in order to see another user's profile. In yet another variation, seeing the other user's profile may be free but a connection is required before a transaction request may be sent (or received).

In one embodiment, a third user account holder is an executive or premium account holder. This user does not need to pay a connection fee in order to view, contact, or connect with other users. However, there may be a specific premium account holder fee for this set of privileges.

In one embodiment, if a first user contracts for a first service with a second user, the first user's unique outgoing value increases by one and the second user's unique incoming value increases by one. If they contract additional services in the same direction and for the same kind of service, genre or profession, the first user's repeat outgoing value increases by one and the second user's repeat incoming value increases by one. However, if thereafter the second user contracts with the first user, i.e., in the opposite direction, whether for the same or different kind of service, genre, or profession, than the second user's unique outgoing value increases by one and the first user's unique incoming value increases by one. Afterwards, additional opposite directional transactions will increase by one the repeat outgoing and repeat incoming values, respectively.

### BRIEF DESCRIPTION OF THE DRAWINGS

FIG. 1 shows an exemplary system diagram.

FIGS. 2-4 show exemplary system processes.

### DETAILED DESCRIPTION

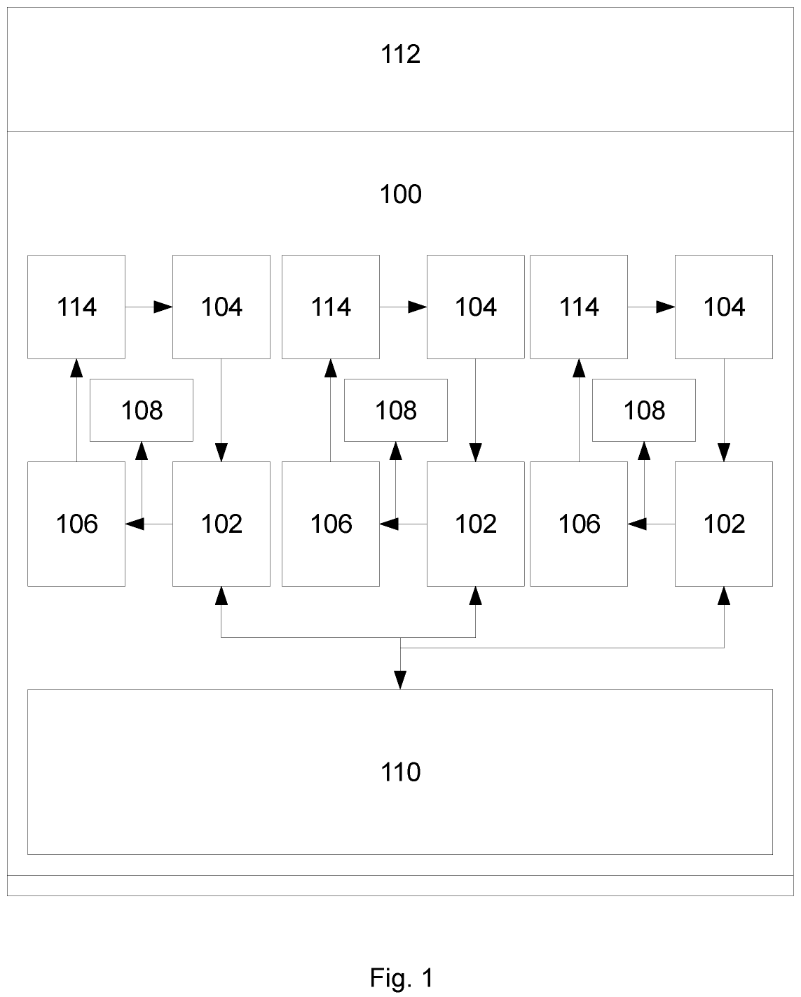

As shown in FIG. 1, a set of processors 100 may include a control processor 110 and a set of user processors 102 coupled to input devices 104 and display screens 106 and associated with user accounts 108. These processors may be connected over a network 112. Each user processor may be operated by a user 114 via the input devices and each user account may be connected to a user's financial account 116.

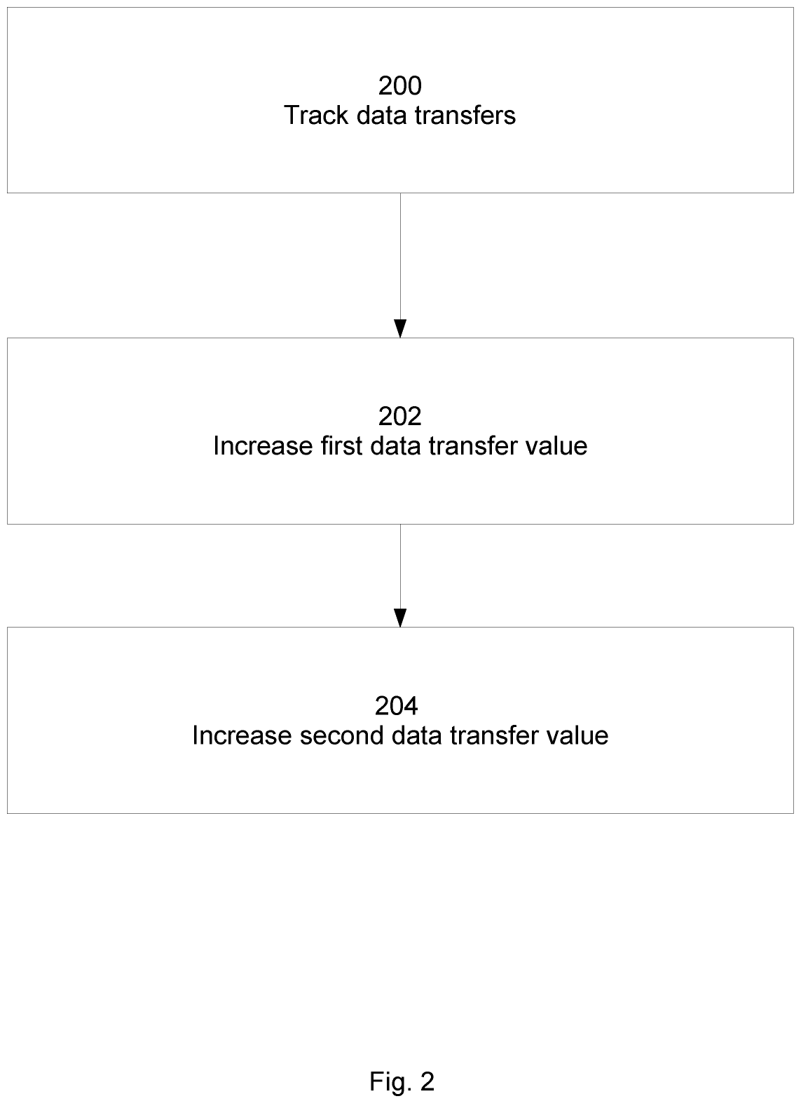

As shown in FIG. 2, the control processor may be programmed to track data transfers occurring between user processors 200, increase a first data transfer value when a data transfer occurs between a data providing processor and new data requesting processors 202, and increase a second data transfer value when a data transfer occurs between the data providing processor and data requesting processors who previously requested at least one data transfer 204. Data transfer tracking may occur by relaying all requests for data transfer from data requesting processors to the control processor and then to the data providing processor, then relaying acceptance of the transfer from the data providing processor to the control processor, then simultaneously or sequentially relaying the data transfer from the data providing processor to the control processor or directly to the data requesting processor and fund transfers from financial accounts associated with the data requesting processors to a financial account associated with the control processor or directly to a financial account associated with the data providing processor.

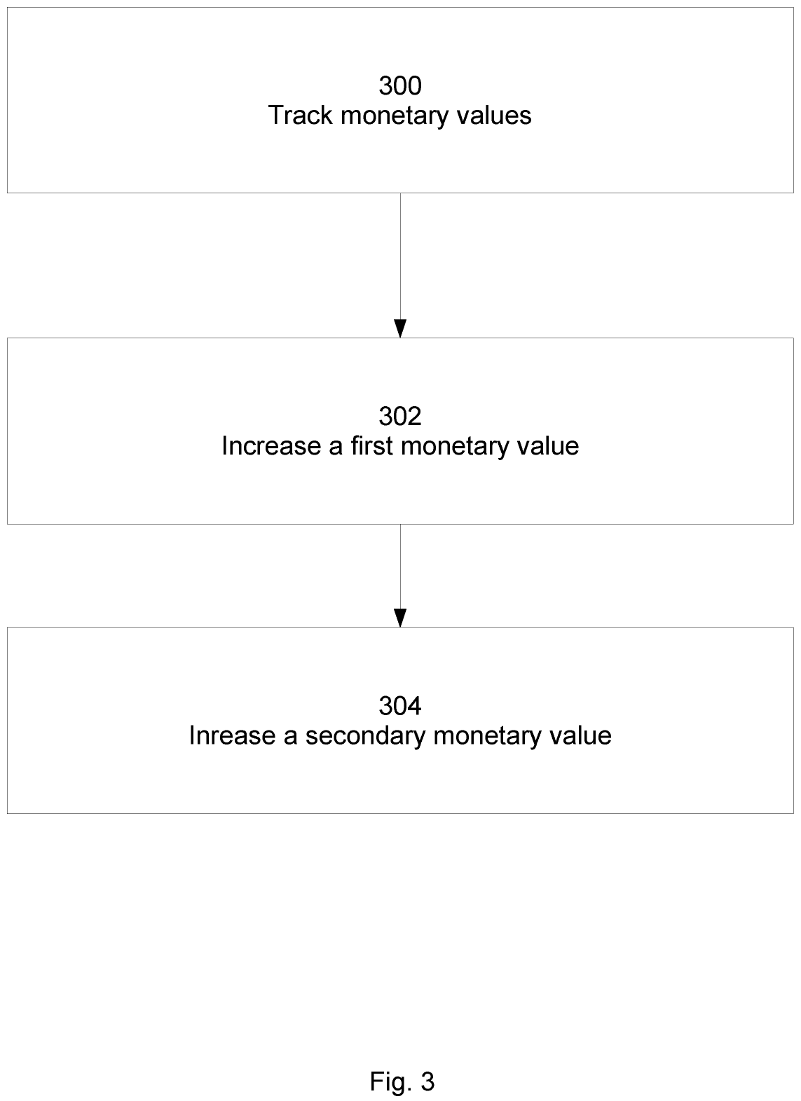

As shown in FIG. 3, the control processor may be programmed to track monetary values associated with data transfers occurring between the user processors 300, increase a first monetary value when the data transfer occurs between the data providing processor and new data requesting processors 302 and increase a second monetary value when the data transfer occurs between the data providing processor and data requesting processors who previously requested at least one data transfer 304;

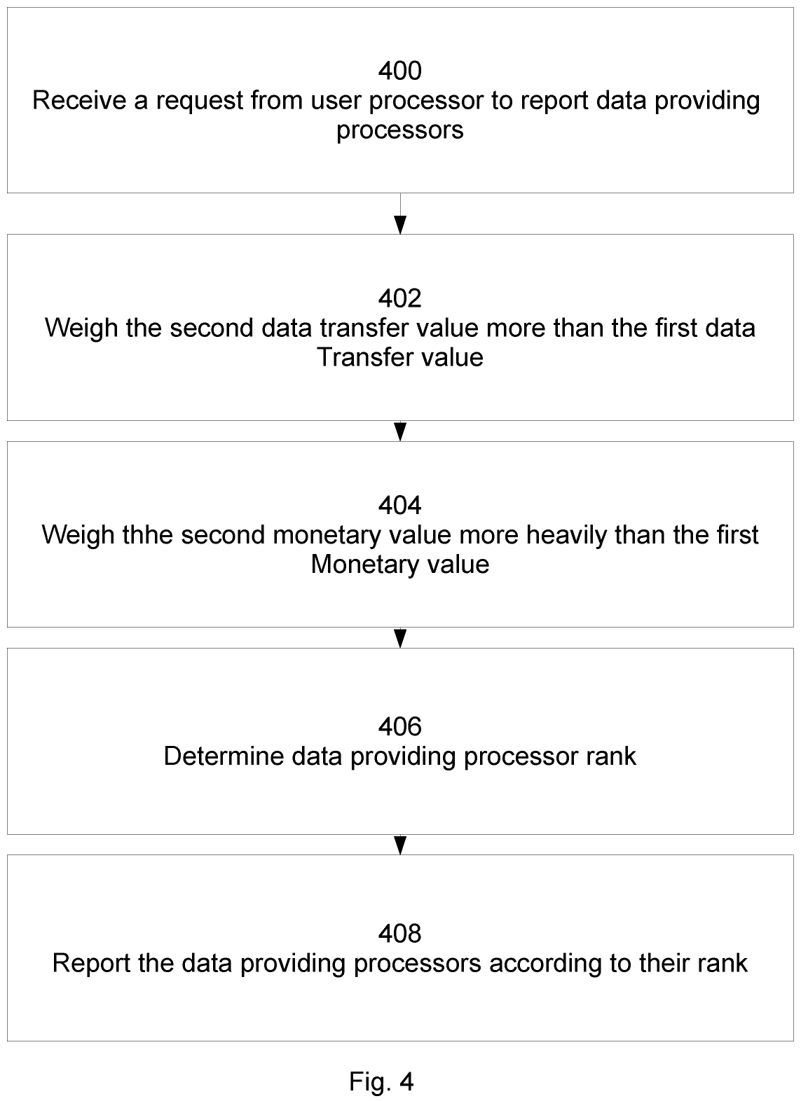

As shown in FIG. 4, the control processor may be programmed to, upon receiving a request from one of the user processors to report data providing processors that provide the particular data transfer 400, weigh the second data transfer value more heavily than the first data transfer value 402, weigh the second monetary value more heavily than the first monetary value 404, determine data providing processor rank for a particular data transfer using the monetary values and data transfer values assigned to each data providing processor and associated with the particular data transfer 406, report the data providing processors according to their rank for that particular data transfer 408.

Factors that may also enter into the ranking calculation including the geographical distance between the data requesting processor and the data providing processors, whether the processors have transferred data before, the price for a given data transfer service, whether a given data providing processor is related, through past transactions, proximity, or communication, with other data requesting processors related to the data requesting processor.

The system may provide a user interface. The user interface may include a user profile page, the profile page including a profile image, name, occupation section, geographical location, and skill and expertise description. The profile image section may feature one or more scrollable images, each providing for click-magnify access. The name section may display a user name or formal name. The occupation section may feature one or more primary jobs or skill sets, optionably clickable. By clicking on a primary job or skill set, information about the job or skill sets or a list of other uses that have also added the job or skill set may be displayed. The primary job or skill set may be entered by the user during a profile creation/edit stage or selected from a list provided by the system. The geographical section may identify the country, state/province, city, borough/region, and/or zip code of the user. The geographic information may be automatically uploaded via a device's GPS application or manually entered or selected by the user. The skill and expertise description may be a few lines or a paragraph describing the particular skills or other resume-related information associated with the user.

The profile page may display or link to another page that displays a service section.

The service section may identify a price or price range, a service description, and/or an occupation associated with a service. Each service, with or without its relevant description, may be hyperlinked to another page or pop-up frame providing additional information and transaction-related actions available to the viewing user.

The profile page, profile edit page, or a referentially linked page may display a field entry or selection interface for receiving personal information from the user, such as the legal name, email, phone number, date of birth, gender, username or alias, zip code, biography, services, service prices, service genres, active/inactive service controls, add/delete service controls, and links to one or more other social media or media related sites. The active/inactive service controls receive commands from a user to display or hide certain services or other information, either pertaining to personal information or service information, such as pricing. The user interface may also provide format controls, allowing the user to determine the way in which certain portions of the service section are displayed as well as what options viewing users have to interact with those services. The links to the social media or media related sites allow a user to identify urls or login to those social media sites in order to access via APIs information, media, or financial content and/or access. In one variation, the user may control what background or icons are displayed on the profile or referentially linked page. The profile page may also display to a viewing user connect controls, allowing the viewing user to request a connection with the user of the viewed profile or to send text communications.

The system provides a communication functionality or interface, as manifested in a connection page, which may comprise one or more separate pages or tabs. On a first tab, incoming connections or requests to connect are displayed, optionally in a list format. Each item on the list may represent a discrete request, or it may be expanded to a set of one or more separate requests. In one variation, the set of requests are sent by the same user but in reference to multiple and distinct services. In another variation, the set of requests are sent by different users but in reference to the same service. Each distinct request may feature the user sending the request, the service requested, the date on which the date is requested, a date by which the service is requested to be started or completed, a price or price range, a message, and/or an actionable control set. The actionable control set may include accept and reject controls to be used by the viewing user. As shown in FIG. 6, a second tab may display outgoing connections or requests. This tab may be similar to the first tab except here, requests sent by the viewing user are displayed. Generally, requests or connections in the first or second tab are pending—that is, they have not yet been accepted, rejected, or responded to. In one variation, either or both of the first and second tabs have a control option for a counter-offer—that is, a new price may be entered or selected by the viewing user to be communicated to the user on the opposite side of the transaction or communication. A third tab may be similar to the first and second except here finalized transactions are displayed.

Each of the services in the incoming, outgoing, and/or finalized tab may be selected by the viewing user. Upon selection, a message or chat function is provided by the system via a chat interface. Comments are displayed chronologically, with more recent communications listed on lower than less recent communications so that eventually the latter are no longer displayed unless the screen is scrolled toward them.

The system may provide for a search functionality and interface. The search functionality may provide for searching through profiles based on one or more profile aspects, such as username or alias, location, skill set, etc. Filters may be applied, such as gender, genre or occupation category, distance from searching user, availability dates, or any other aspect. Filtering may occur by selecting one or more terms that appear on the user interface, including those that appear after triggering a drop-down menu or calendar pop-up. These drop-down menu's and pop-ups may be scroller or otherwise navigated to view the full list of aspect species. In one embodiment, the user may select a geographic tab or graphic, causing the system to display a map. The user may drop a pin or graphic onto the map to signify his or her location and/or a location around which the user wishes to search for profiles. The user may identify a distance to signify how far from the pin the results with relevant location are to be displayed, or a default distance may be provided by the system. The system may scan the database for the relevant results and display them on a result page or graphical section. The displays may comprise profile synopses, which detail fewer aspects than the profile pages proper. These profiles may be selected by the viewing user to request the system to display the contents of the profiles—namely, the profile pages.

Profile pages may be added by the viewing user to a favorite list, either on the favorited profile page itself or via a control on the user interface adjacent to a profile synopsis. Relatedly, a viewing user may view profile pages or synopses of users that have added the user to their favorite list.

A profile tab may display an activity log, which may feature past or ongoing transactions. The activity log may feature a first and second portion, directed toward incoming transactions and outgoing transactions, respectively, where incoming transactions signify requests for services from other users and outgoing transactions signify requests the viewing user has made of other users. It is conceivable that the appelation is arbitrary and may be switched. The activity log may categorize the services according to the skill set, genre, or occupation, such that each category is featured as a separate item. Each item may be displayed with the number of unique and/or repeat transactions. Each of these items may be selected by the viewing user to display the list of transactions that comprise the item.

Each transaction may be displayed with a corresponding date of starting or completion.

1. A system comprising user processors and a control processor, the user processors coupled to input devices and display screens and associated with user accounts, the user processors and the control processor connected over a network;
a. the control processor programmed to track data transfers occurring between the user processors, increase a first data transfer value when a data transfer occurs between a data providing processor and new data requesting processors, and increase a second data transfer value when a data transfer occurs between the data providing processor and data requesting processors who previously requested at least one data transfer;
b. track monetary values associated with data transfers occurring between the user processors, increase a first monetary value when the data transfer occurs between the data providing processor and new data requesting processors and increase a second monetary value when the data transfer occurs between the data providing processor and data requesting processors who previously requested at least one data transfer;
c. determine data providing processor rank for a particular data transfer using the monetary values and data transfer values assigned to each data providing processor and associated with the particular data transfer;
d. weigh the second data transfer value more heavily than the first data transfer value when determining data providing processor rank;
e. weigh the second monetary value more heavily than the first monetary value when determining data providing processor rank;
f. only increase the second data transfer value when the data transfer occurring between the data providing processor and data requesting processors who previously requested at least one data transfer is of a same particular data transfer type as a previous data transfer between the data providing processor and data requesting processors who previously requested at least one data transfer;
g. only increase the first data transfer value when a particular monetary amount associated with a particular data transfer is equal or greater than a threshold amount set by an operator of the fourth processor;
h. upon receiving a request from one of the user processors to report data providing processors that provide the particular data transfer, report the data providing processors according to their rank for that particular data transfer.

2. A system comprising a set of processors connected over a network, the set of processors programmed to:
a. track transactions occurring between users, increase a first transaction value when a transaction occurs between a provider and new customers, and increase a second transaction value when a transaction occurs between the provider and repeat customers.

3. The system of claim 2, the set of processors programmed to:
a. track monetary values associated with transactions occurring between users, increase a first monetary value when the transaction occurs between the provider and new customers and a second monetary value when the transaction occurs between the provider and repeat customers.

4. The system of claim 3, the set of processors programmed to:
a. determine provider rank for a particular service using the monetary values and transaction values assigned to each provider and associated with the particular service.

5. The system of claim 3, the set of processors programmed to:
a. determine provider rank for a particular service using the monetary values and transaction values assigned to each provider and associated with the particular service or associated with other services related to the particular service.

6. The system of claim 5, with services being related if they are in the same area of expertise.

7. The system of claim 5, with services being related if they involve the same technique.

8. The system of claim 4, the set of processors programmed to:
a. weigh the second transaction value more heavily than the first transaction value when determining provider rank.

9. The system of claim 4, the set of processors programmed to:
a. weigh the second monetary value more heavily than the first monetary value when determining provider rank.

10. The system of claim 4, the set of processors programmed to:
a. weigh the second monetary value more heavily than the second transaction value when determining provider rank.

11. The system of claim 4, the set of processors programmed to:
a. weigh the second transaction value but not the first transaction value when determining provider rank.

12. The system of claim 4, the set of processors programmed to:
a. weigh the second monetary value but not the first monetary value when determining provider rank.

13. The system of claim 2, the set of processors programmed to:
a. only increase the second transaction value when the transaction occurring between the provider and the repeat customers is of a same particular service type as a previous transaction between the provider and the repeat customers.

14. The system of claim 2, the set or processors programmed to:
a. only increase the second transaction value when the transaction occurring between the provider and the repeat customers is of a same or similar particular service type as a previous transaction between the provider and the repeat customers.

15. The system of claim 2, the set or processors programmed to:
a. only increase the second transaction value when the transaction occurring between the provider and the repeat customers is in a same area of expertise as a previous transaction between the provider and the repeat customers.

16. The system of claim 2, the set or processors programmed to:
a. only increase the second transaction value when the transaction occurring between the provider and the repeat customers involves a same technique as a previous transaction between the provider and the repeat customers.

17. The system of claim 2, the set of processors programmed to:
a. only increase the first transaction value when a particular monetary amount associated with a particular transaction is equal or greater than a pre-set threshold.

18. A system comprising a set of processors connected over a network, the set of processors programmed to:
a. track transactions occurring between users, increase a first transaction value when a transaction occurs between a provider and new customers, and increase a second transaction value when a transaction occurs between the provider and repeat customers;
b. track monetary values associated with transactions occurring between users, increasing a first monetary value when the transaction occurs between the provider and new customers and a second monetary value when the transaction occurs between the provider and repeat customers;
c. determine provider rank for a particular service using the monetary values and transaction values assigned to each provider and associated with the particular service;
d. weigh the second transaction value more heavily than the first transaction value when determining provider rank;
e. weigh the second monetary value more heavily than the first monetary value when determining provider rank;
f. only increase the second transaction value when the transaction occurring between the provider and the repeat customers is of a same particular service type as a previous transaction between the provider and the repeat customers; and
g. only increase the first transaction value when a particular monetary amount associated with a particular transaction is equal or greater than a pre-set threshold.

19. The system of claim 18, the set of processors programmed to:
a. weigh the second transaction value but not the first transaction value when determining provider rank.

20. The system of claim 18, the set of processors programmed to:
a. weigh the second monetary value but not the first monetary value when determining provider rank.
